(19) United States
(12) Patent Application Publication
(10) Pub. No.: US 2020/0104076 A1
(43) Pub. Date: Apr. 2, 2020

(54) DIMENSIONAL DIRECT MEMORY ACCESS CONTROLLER

(71) Applicant: QUALCOMM Incorporated, San Diego, CA (US)

(72) Inventors: Jinxia BAI, San Diego, CA (US); Rosario CAMMAROTA, San Diego, CA (US); Michael GOLDFARB, San Diego, CA (US)

(21) Appl. No.: 16/585,949

(22) Filed: Sep. 27, 2019

Related U.S. Application Data
(60) Provisional application No. 62/738,753, filed on Sep. 28, 2018.

(51) Int. Cl. G06F 3/06; G06F 12/02; G06F 12/10; G06N 3/063

(52) U.S. Cl. CPC G06F 3/0659; G06F 12/0207; G06N 3/063; G06F 3/0604; G06F 3/0673; G06F 12/10

(57) ABSTRACT

The present disclosure provides a method of accessing data from a first memory. The method may include receiving a command for accessing a first portion of the data. The data includes a plurality of words arranged as a multi-dimensional array of words that is stored contiguously in the first memory. The method may further include mapping the first portion of the data to a first portion of the plurality of words. The first portion of the plurality of words is not stored contiguously in the first memory. The method may further include accessing the first portion of the plurality of words while refraining from accessing at least a second portion of the plurality of words that is contiguously stored between at least two words of the first portion of the plurality of words.

### CROSS-REFERENCE TO RELATED APPLICATIONS

This application claims the benefit of U.S. Provisional Patent No. 62/738,753, filed Sep. 28, 2018. The content of the provisional application is hereby incorporated by reference in its entirety.

### TECHNICAL FIELD

The teachings of the present disclosure relate generally to memory access, and more specifically to a dimensional direct memory access circuit and controller and techniques for using the same.

### BACKGROUND

Modern computing devices can include a large number of processors, memory, and other peripherals. In certain computing devices, the central processing unit (CPU) is configured to process commands to access components such as memory through a bus. However, by using the CPU to control memory operations, the CPU is unavailable to process commands from other components during memory access (e.g., during read and write operations). As a partial solution to this problem, direct memory access (DMA) technology emerged. A DMA circuit and controller (also generally referred to as a DMA) is configured to access memory (e.g., random access memory (RAM)) substantially independent of the CPU, meaning that a CPU may initiate memory access by sending an access command from a client (e.g., a neural processing unit (NPU), etc.) to the DMA, and then the CPU can perform other tasks as the DMA executes memory access (e.g., read, write, etc.). The DMA can signal the CPU (e.g., using an interrupt) when it has completed its operations and the data is accessible to one or more clients (e.g., a client's processing unit(s) and/or its local memory (e.g., cache)). Thus, a DMA can reduce CPU overhead. In certain aspects, a DMA is used to access numerous peripherals and system components including graphics cards, network cards, disc drives (e.g., solid state disks (SSDs)), as well as to provide access for intra-chip data transfer (e.g., using multi-core CPUs) and memory to memory access (e.g., transferring data from a first memory (e.g., a main system memory) to a second memory (e.g., a client cache)).

Generally, data is stored in memory as an array of linearly addressed words. For example, an application can request to write data to memory and a DMA can process the request by writing the data to the memory and including a memory address (e.g., in a DMA register) that corresponds to the location of the data in memory. Memory addresses may refer to a physical or logical memory location. It will be appreciated that a memory address typically refers to the starting location of a word. Each word includes a tag that indicates the size of the word (e.g., indicated by one or more bits in each word) and is used in part to determine when to stop streaming bits for the word.

Currently available DMAs receive a command for access to data, and stream words from a first address to a last address including all linearly addressed words between the first address and the last address associated with the data. For example, data (e.g., a picture, video, etc.) may be stored in a memory as one or more words, and a client can send a command to the DMA (e.g., directly or through the CPU) to access a portion of the data (e.g., certain frames of a video or portions of frames). In this case, a DMA will access the portion of data by streaming all linearly addressed words from a first word to an ending word associated with the data without skipping words, even if the requested data is contained in only a portion of the accessed words (e.g., accessing an entire video). It will be appreciated that processing may then be needed to parse out the portion of data from the accessed data when the data includes unwanted portions of data (e.g., certain frames of the video or portions of frames).

### BRIEF SUMMARY OF SOME EXAMPLES

The following presents a simplified summary of one or more aspects of the present disclosure, in order to provide a basic understanding. This summary is not an extensive overview of all contemplated features of the disclosure, and is intended neither to identify key or critical elements of all aspects of the disclosure nor to delineate the scope of any or all aspects of the disclosure. Its sole purpose is to present concepts of one or more aspects of the disclosure in a simplified form as a prelude to the more detailed description that is presented later.

In certain aspects, the present disclosure provides an improved direct memory access (DMA) circuit and controller and techniques for using the same. The DMA may be integrated into a system-on-chip (SoC) or packaged separately. The DMA may be entirely hardware, software, or a combination of hardware and software.

In some aspects, the present disclosure provides a method of accessing data from a first memory. The method includes receiving a command for accessing a first portion of the data. The data includes a plurality of words arranged as a multi-dimensional array of words that is stored contiguously in the first memory. The method further includes mapping the first portion of the data to a first portion of the plurality of words. The first portion of the plurality of words is not stored contiguously in the first memory. The method further includes accessing the first portion of the plurality of words while refraining from accessing at least a second portion of the plurality of words that is contiguously stored between at least two words of the first portion of the plurality of words.

In some aspects, the present disclosure provides a system-on-chip (SoC). The SoC includes a first memory storing, contiguously, data comprising a plurality of words arranged as a multi-dimensional array of words. The SoC further includes a direct memory access (DMA) controller coupled to the first memory. The DMA controller is configured to receive a command for accessing a first portion of the data. The DMA controller is configured to map the first portion of the data to a first portion of the plurality of words, wherein the first portion of the plurality of words is not stored contiguously in the first memory. The DMA controller is configured to access the first portion of the plurality of words while refraining from accessing at least a second portion of the plurality of words that is contiguously stored between at least two words of the first portion of the plurality of words.

In some aspects, the present disclosure provides a system-on-chip (SoC). The SoC includes means for receiving a command for accessing a first portion of the data, wherein the data comprises a plurality of words arranged as a multi-dimensional array of words that is stored contiguously in the first memory. The SoC further includes means for mapping the first portion of the data to a first portion of the plurality of words, wherein the first portion of the plurality of words is not stored contiguously in the first memory. The SoC further includes means for accessing the first portion of the plurality of words while refraining from accessing at least a second portion of the plurality of words that is contiguously stored between at least two words of the first portion of the plurality of words.

In some aspects, the present disclosure provides a non-transitory computer readable medium storing instructions that when executed by a direct memory access (DMA) controller cause the DMA controller to perform a method of accessing data from a first memory. The method includes receiving a command for accessing a first portion of the data. The data includes a plurality of words arranged as a multi-dimensional array of words that is stored contiguously in the first memory. The method further includes mapping the first portion of the data to a first portion of the plurality of words. The first portion of the plurality of words is not stored contiguously in the first memory. The method further includes accessing the first portion of the plurality of words while refraining from accessing at least a second portion of the plurality of words that is contiguously stored between at least two words of the first portion of the plurality of words.

Various additional and alternative aspects are described herein. In some aspects, the present disclosure provides a method of accessing data structured as an array of words from a first memory with a direct memory access (DMA) controller, wherein the memory comprises a plurality of words that are addressed linearly, and wherein the data is mapped to the plurality of words. The method includes receiving by the DMA a command for accessing a portion of the data. The method further includes determining dimensional information based in part on the portion of data. The method further includes mapping the portion of the data to a portion of the plurality of words based in part on dimensional information. The method further includes accessing the portion of the plurality of words.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain aspects of this disclosure and are not to be considered limiting of its scope.

FIG. 1 is a block diagram of an example DMA coupled to a system-on-chip (SoC) in accordance with certain aspects of the present disclosure.

FIG. 2 is a block diagram of an example DMA coupled to a neural processing unit (NPU) subsystem in accordance with certain aspects of the present disclosure.

FIG. 3 depicts a block diagram of a memory array in accordance with certain aspects of the present disclosure.

FIG. 4 depicts a block diagram of a memory array in accordance with certain aspects of the present disclosure.

FIG. 5 depicts a block diagram of a memory array in accordance with certain aspects of the present disclosure.

FIG. 6 is a flowchart that illustrates example operations of a DMA in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Although the teachings of this disclosure are illustrated in terms of integrated circuits (e.g., a SoC), the teachings are applicable in other areas and circuit designs. The teachings disclosed should not be construed to be limited to SoC designs or other illustrated embodiments. The illustrated embodiments are merely vehicles to describe and illustrate examples of the inventive teachings disclosed herein.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The term “system on chip” (SoC) is used herein to refer to a single integrated circuit (IC) chip that contains multiple resources and/or processors. A single SoC may include any number of general purpose and/or specialized processors (digital signal processors, modem processors, video processors, NPUs, etc.), memory (e.g., ROM, RAM, Flash, etc.), and other resources (e.g., timers, voltage regulators, oscillators, etc.), any or all of which may be included in one or more cores.

A number of different types of memories and memory technologies are available or suitable for use with the various aspects of the disclosure. Such memory technologies/types include phase change memory (PRAM), dynamic random-access memory (DRAM), static random-access memory (SRAM), non-volatile random-access memory (NVRAM), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory. Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims. The various aspects may be implemented in a wide variety of computing systems, including single processor systems, multiprocessor systems, multicore processor systems, systems-on-chip (SoC), or any combination thereof.

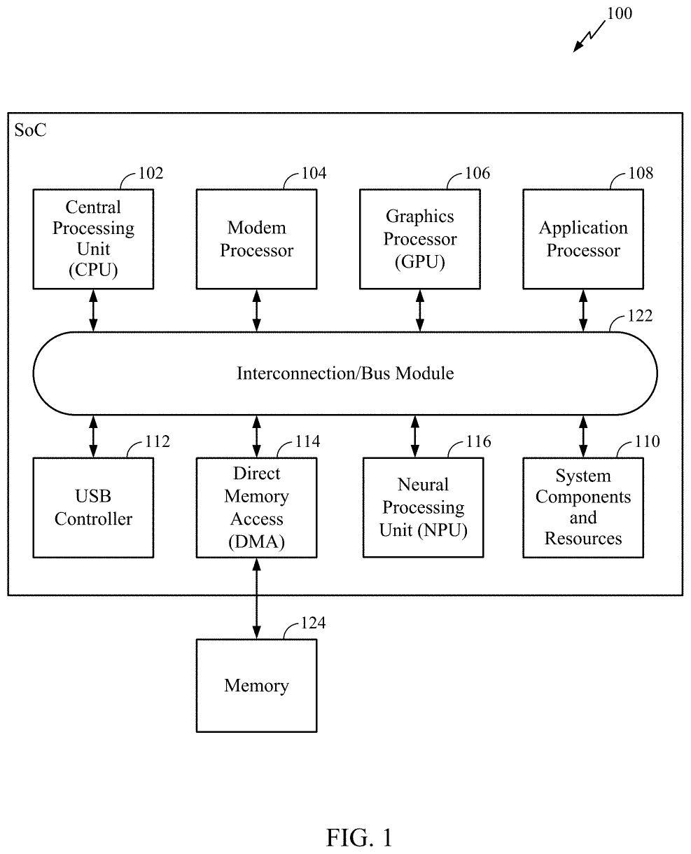

Certain aspects of the present disclosure provide a DMA and techniques for using the DMA as described in more detail below. FIG. 1 is a block diagram of example components and interconnections in a system-on-chip (SoC) 100 suitable for implementing various aspects of the present disclosure. The SoC 100 may include a number of heterogeneous processors, such as a central processing unit (CPU) 102, a modem processor 104, a graphics processor 106, an application processor 108, and a neural processing unit (NPU) 116. Each processor 102, 104, 106, 108, 116, may include one or more cores, and each processor/core may perform operations independent of the other processors/cores. Each processor 102, 104, 106, 108, 116 may be part of a subsystem (not shown) including one or more processors, caches, etc. configured to handle certain types of tasks or computations, and in certain aspects may be referred to as a client. It should be noted that SoC 100 may include additional processors and or memory (not shown) or may include fewer processors.

The SoC 100 may include system components and resources 110 for managing sensor data, analog-to-digital conversions, wireless data transmissions, and for performing other specialized operations (e.g., decoding high-definition video, image processing, tensor calculations, etc.). System components and resources 110 may also include components such as voltage regulators, oscillators, phase-locked loops, peripheral bridges, data controllers, system controllers, access ports, timers, and other similar components used to support the processors and software clients running on the computing device. The system components and resources 110 may also include circuitry for interfacing with peripheral devices, such as cameras, electronic displays, wireless communication devices, external memory chips, etc.

The SoC 100 may further include a universal serial bus (USB) controller 112 for connecting to one or more USB enabled devices or components. SoC 100 also includes DMA 114 for controlling one or more types of memory in accordance with certain aspects of the disclosure. The SoC 100 may also include an input/output module (not shown) for communicating with resources external to the SoC, such as a clock and a voltage regulator, each of which may be shared by two or more of the internal SoC components.

The processors 102, 104, 106, 108, 116 may be interconnected to the USB controller 112, DMA 114, system components and resources 110, and other system components via an interconnection/bus module 122, which may include an array of reconfigurable logic gates and/or other bus architecture. Communications may also be provided by advanced interconnects, such as high performance networks-on chip (NoCs) and may utilize remote processors, memory, and the like.

The interconnection/bus module 122 may include or provide a bus mastering system configured to grant SoC components (e.g., processors, peripherals, etc.) exclusive control of the bus (e.g., to transfer data) for a set duration, number of operations, number of words, etc. In an aspect, the bus module 122 and/or DMA 114 may enable components (or clients) connected to the bus module 122 to operate as a master client and initiate memory access commands. The bus module 122 may also implement an arbitration scheme to prevent multiple master clients from attempting to drive the bus simultaneously.

DMA 114 may be a specialized hardware module configured to manage the flow of data to and from a component, such as a first memory (e.g., memory 124 (e.g., main system memory)) and clients (e.g., to one or more processors of a client and/or a second memory such as memory accessible to one or more client (e.g., client cache)). DMA 114 may include logic for interfacing with the memory 124, which may include hardware (e.g., a plurality of hardware registers), software, or a combination of hardware and software. The memory 124 may be an on-chip component (e.g., on the substrate, die, integrated chip, etc.) of SoC 100, or alternatively (as shown) an off-chip component.

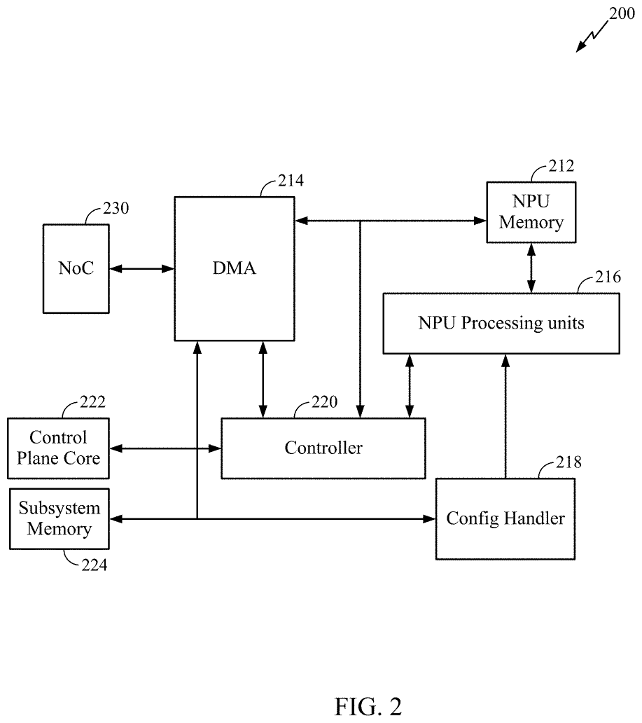

FIG. 2 is a block diagram of a DMA 214 integrated into a client (e.g., an NPU subsystem) in accordance with certain aspects of the present disclosure. In certain aspects, the DMA 214 corresponds to DMA 114 of FIG. 1. It will be appreciated that a DMA may be integrated into other clients in whole or in part. As shown, NPU subsystem 200 includes NPU memory 212 (e.g., cache, tightly coupled memory (TCM), SRAM, etc.) and NPU processing units 216. In certain aspects, NPU processing units 216 and NPU memory 212 correspond to components of NPU 116 of FIG. 1. NPU memory 212 can store memory accessed (e.g., streamed) from other memory (e.g., memory 124 in FIG. 1), by DMA 214. In certain aspects, NPU processing units 216 process data accessed by DMA 214. In certain aspect, NPU processing units 216 includes one or more processors, accelerators, or other compute units. For example, in certain aspects, NPU processing units 216 are accelerators configured to efficiently perform numerous matrix operations on a stream of input data tensors retrieved from memory (e.g., memory 124) by the DMA 214. In certain aspects, NPU processing units 216 are designed as hardware accelerators for artificial intelligence applications, such as artificial neural networks, machine vision, and machine learning.

In certain aspects, NPU subsystem 200 may send a command to DMA 214 (e.g., directly, through controller 220, etc.) to access a portion of data (e.g., a portion of an image, video, etc. stored in main system memory (not shown), such as memory 124). Controller 220 is coupled to control plane core 222, which may be a processing unit (e.g., an ARM based processing unit) for assisting with operations of NPU processing units 216. In certain aspects, controller 220 and control plane core 222 are components of NPU 116 of FIG. 1 or are components of DMA 114 of FIG. 1.

In certain aspects, if NPU subsystem 200 is, e.g., used to determine whether data (e.g., a video) contains a human, it may be desirable to process a portion of the data (e.g., video frames indicative of movement), rather than processing all of the data (e.g., video frames with no movement). It will be appreciated that in certain aspects, the portion of data may be located in various discontinuous portions of a memory array (e.g., discontinuously addressed words). This may be the case because each frame of a video was written to main system memory linearly frame by frame. Thus, for example, frames with movement may be separated by data (e.g., one or more words) corresponding to frames without movement. Thus, if a client using a traditional DMA sends a command to access a portion of data (e.g., frames with movement), then unwanted data would be accessed as the data is not mapped to contiguous words.

In another example, if NPU subsystem 200 is, e.g., used to determine whether data (e.g., a frame) contains a human, it may be desirable to process a portion of the data (e.g., a portion of the frame indicated as changed from a previous frame), rather than processing all of the data (e.g., the entire frame). It will be appreciated that in certain aspects, the portion of data may be located in various discontinuous portions of a memory array (e.g., discontinuously addressed words). This may be the case because each frame of a video was written to main system memory linearly frame by frame. Thus, for example, if the lower right corner of a frame is indicated as having changed from a previous frame, the lower right corner of the frame is likely to be located in different sections of the memory array separated by data (e.g., one or more words) containing unwanted portions of the frame. Thus, if a client using a traditional DMA sends a command to access a portion of data (e.g., data of the lower right corner of the frame), then unwanted data would be accessed as the data is not mapped to contiguous words. In yet another example, the NPU subsystem 200 may want to access portions of multiple frames (e.g., corresponding to the same location with respect to each frame, such as the lower right corner of the frame) across multiple frames of a video, such as for object tracking in the video.

As data increases in size (e.g., large format videos, high-definition images, multidimensional data, etc.), accessing data within the linearly addressed memory array can use large memory bandwidth and require significant post processing. Thus, it will be appreciated that by reducing the amount of data accessed by the DMA, the DMA can reduce the bandwidth of the memory bus and overall processing compared to accessing unwanted data for the client and then parsing out the desired portion of the data by the client. However, traditional DMAs are not capable of determining dimensional information based on the portion of the data across discontinuous words as they access data linearly without dimensional control.

In contrast, DMA 214 is capable of streaming a portion of data (e.g., the lower right corner of a video across frames of the video) from a first memory location (e.g., main system memory (e.g., memory 124 in FIG. 1)), to a client (e.g., NPU memory 212, subsystem memory 224, NPU processing units 216, etc.) without accessing all the data (e.g., portions of the video other than the lower right corner of a video across a number N frames of the video). Thus, reduced memory bandwidth and increased system performance are achieved.

Config handler 218 is coupled to subsystem memory 224. Config handler 218, in certain aspects, is a component of NPU 116 of FIG. 1 or of DMA 114 of FIG. 1. In certain aspects, subsystem memory 224 is a component of NPU 116 of FIG. 1. Config handler 218 may be used for further processing and configuration of the data, (e.g., to determine dimensional information based in part on the data, to program block size as described below, etc.). In certain aspects, subsystem memory 224 comprises working memory for components of NPU subsystem 200 such as config handler 218, NPU processing units 216, etc., such as for storing the data retrieved from other memory (e.g., memory 124). NoC 230 is coupled to DMA 214 and may correspond to interconnection 122 of FIG. 1.

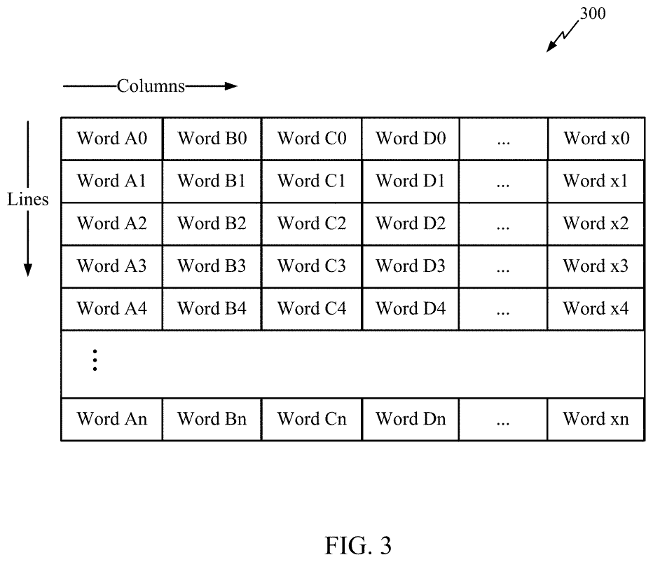

FIG. 3 is a block diagram depicting a memory array 300 according to certain aspects of the disclosure. Memory array 300 may correspond to contents of memory 124 of FIG. 1. Memory array 300 includes a number of columns along the x axis and a number of lines along they axis. Memory array 300 includes a number of words along a first line 0 (e.g., Word A0—Word x0, where ‘x’ represents any character(s) such that there are any integer number of columns (i.e., words) per line, and where ‘n’ represents any number such that there are any integer number of lines) with each word containing a number of bits. It will be appreciated that each word may contain a different number of bits or one or more words may contain the same number of bits (e.g., 32 bits, 64 bits, etc.). It will be appreciated that each word is linearly addressed (e.g., addressed in order: Word A0, Word B0, . . . Word x0, Word A1, Word B1, and continuing to Word xn.). For example, a traditional DMA may associate an address to a first word (e.g., in a DMA hardware register) and increment the address by one address that is indicative of each word location.

For example, if data (e.g., a video) is saved in memory array 300, and a client using a traditional DMA sends a command for a portion of data (e.g., an image of an object across three video frames), and the portion of data is contained in a first block (e.g., a portion of memory comprising a number of words across one or more columns and a number of lines) that includes Word A0 and Word B0 (the image of the object in a first video frame), a second block that includes Word A1 and Word B1 (the image of the object in a second video frame), and a third block that includes Word A2 and Word B2 (the image of the object in a third video frame), then a traditional DMA may access the entire three video frames in a linear stream of words (e.g., streaming Word A0—Word x0 along line 0, then Words A1—Word xl along line 1, and then Words A2—Word x2 along line 2). It should be noted that though for ease of explanation each line of memory array 300 is described as corresponding to a frame of video, a frame of video may correspond to a portion of a line, to words on more than one line, etc. It will be appreciated that in the above example, the DMA accessed unwanted data (e.g., unwanted portions of the three video frames (e.g., Word C0—Word x0, Word C1—Word x1, and Word C2—Word x2)).

In contrast, a DMA in accordance with the present disclosure (e.g., DMA 114 in FIG. 1, DMA 214 in FIG. 2, etc.) is capable of accessing the words containing the data in the command for access (e.g., Word A0, Word B0, Word A1, Word B1, Word A2, and Word B2) based in part on dimensional information stored by the DMA when writing the data to a plurality of words. For example, the DMA can store dimensional information to hardware or software registers. For example, for a two dimensional picture, the DMA can store dimensional information indicative of x and y dimensions of the data. It will be appreciated that dimensional information indicative of any number of dimensions may be stored. Thus, when a client sends a command for a portion of the data (e.g., the lower right hand corner of the picture) the DMA can map the portion of the data to the plurality of words containing the portion of the data, and access the portion of the plurality of words without access neighboring words, e.g., other words on the same lines and/or columns.

For example, a picture may be saved to Words A0—Word xn in memory array 300, but the portion of data requested by a client is located at Word A0, Word B0, Word A1, and Word B1 in the memory array, in this example corresponding to a block, but it should be noted these words could also correspond to a portion of a block or multiple blocks. The DMA can access its registers to determine dimensional information based in part on the portion of the data and then map the portion of data to the block of words comprising Word A0, Word B0, Word A1 and Word B1. The DMA can then access the portion of words rather than all of the words in memory array 300, all of the words on lines 0 and 1, and/or all of the words on columns A and B. It will be appreciated that in certain aspects, the DMA does not included any unwanted data (e.g., Word C0—Word x0, Word C1—Word x1, and Word A2—Word xn). In other aspects, one or more words of unwanted data may be included when accessing the potion of the plurality of words. (e.g., the granularity of dimensional information is larger than the granularity of requested data). It will be appreciated that the granularity of dimensional information is programmable. For example, dimensional information may be associated with each word, or blocks of words. In certain aspects it may be preferable to have a larger granularity (e.g., large blocks of words) as it may require a smaller hardware register. In other aspects, a smaller granularity is preferable (e.g., a single word) as less unwanted data is likely to be included during memory access. The granularity may be determined by a client, preprogramed, or may be configurable, etc. For example, if a high-definition image is being analyzed, and the smallest granularity analyzed by the client in the image is a 2 dimensional section of X by Y pixels associated with no less than a block of 50 words (e.g., of any dimension of columns and lines, such as 5×10, 10×5, 2×25, 25×2, etc.), then the DMA may be configured with a granularity of blocks of 50 words, as a finer granularity would not be an efficient use of the DMA registers.

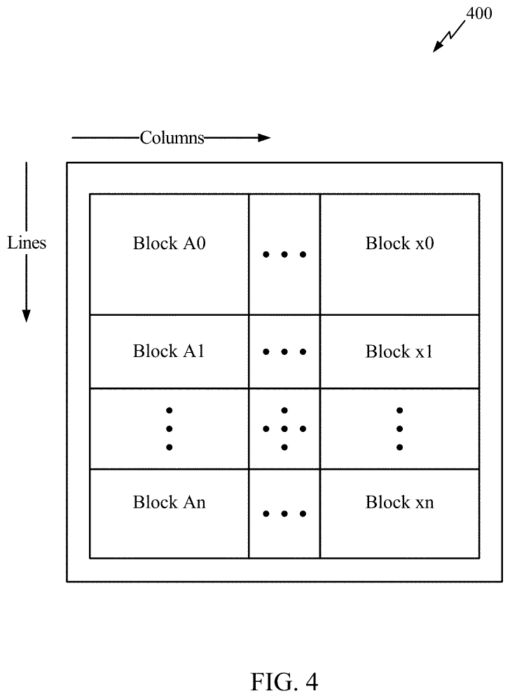

FIG. 4 is a block diagram depicting a memory array 400 according to certain aspects of the disclosure. Memory array 400 may correspond to contents of memory 124 of FIG. 1. Array 400 includes a number of columns along the x axis and a number of lines along the y axis. Memory array 400 includes a number of blocks, wherein each block includes a number K words across one or more columns in the x dimension, and a number Z words down one or more lines in the y dimension. In certain aspects, Block A0 is a block that includes at least one word with a given word length (e.g., 64 bits). In other aspects, Block A0 may be several words in length in the x dimension and several words in length in the y dimension. Thus it will be appreciated that a block may include a group of one or more words.

A DMA in accordance certain aspects of the present disclosure (e.g., DMA 114 in FIG. 1, DMA 214 in FIG. 2, etc.) is capable of accessing certain blocks of data by using in part dimensional information. For example, the DMA may receive a request from a client (e.g., an NPU), to access (e.g., read or write) memory from main system memory (e.g., memory 124 in FIG. 1) to client memory (e.g., NPU 116 in FIG. 1, NPU memory 212 in FIG. 2, subsystem memory 224 in FIG. 2, etc.). The request from the client may comprise data mapped to noncontiguous blocks, such as portions of one or more frames in a video. For example, when data such as a video is accessed (e.g., written) in the main system memory, the DMA can include in a hardware register dimensional information indicative of the location of data within the memory array (e.g., where each video frame is located, where each section of each frame is located, etc.). It will be appreciated that dimensional information may be indicative of an exact location of each word or block and/or indicative of relationship information (e.g., indicating that corresponding sections of video frame are offset by a certain number of words or blocks). Thus, if a section of a video is requested by a client (e.g., the lower right corner), then the DMA may determine the location of a block corresponding to the portion of data in the first frame, and then based on an offset between frames, map the data to one or more words in the memory array. In certain aspects, offsets may be stored as dimensional information (e.g., in a hardware register accessible to the DMA, etc.).

For example, a client may send a command to the DMA to access a portion of data (e.g., an object located in the first two frames of a video, wherein the object in the first frame of the video is located in Block A0 and the object in the second frame of the video is located in Block A1 in FIG. 4). The DMA may determine dimensional information based on the portion of data (e.g., Block A0 and a 1 Block offset in the y dimension) based, for example, on one or more DMA registers. The DMA may then map the portion of data to the words (e.g., to the words in Block A0 and Block A1). The DMA can access the portion of the data in memory array 400 without including unwanted data (e.g., accessing blocks Block A0 and Block A1 without accessing all of the blocks of data between the first block and last block containing the portion of data (e.g., without accessing Block B1—Block x0)).

In certain aspects, the portion of data may span multiple dimensions. For example, in certain video frames, (e.g., the first ten video frames) an object does not move, and the DMA accesses Block A0—Block An, which includes data indicative of the portion of data containing the object. Then in the next ten video frames the object moves, and the NPU sends a command to the DMA for portions of the data indicative of the moving object. The DMA may determine based in part on dimensional information to now access different portions of the data for the next ten video frames (e.g., Block B0—Block Bn).

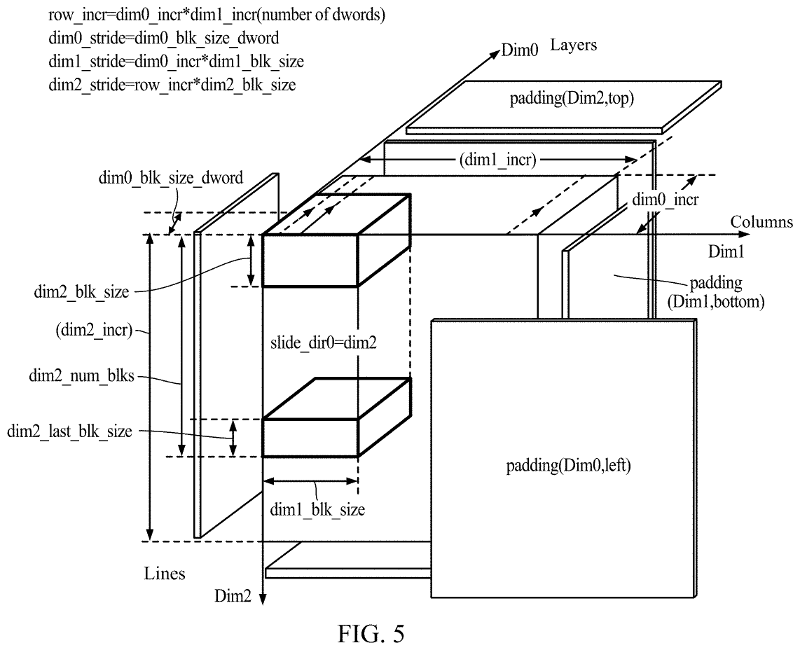

In certain aspects, a memory array may include more than two dimensions, for example 3 dimensions as shown in FIG. 5. In certain aspects, a memory array can have N independent dimensions (e.g., 2, 3, 4, etc. (e.g., multiple multidimensional memory arrays)). It will be further appreciated that the DMA can access information in more than one dimension and across the same dimension multiple times (e.g., a first time in the x dimension, a second time in the y dimension, a third time in the x dimension, a fourth time in the y dimension, and a fifth time in the z dimension, etc.). In certain aspects dimensional information is based in part on a preprogramed granularity (e.g., a block size) as described above. In certain aspects, dimensional information is in part determined in substantially real time based on one or more commands from a client (e.g., controller 220 and/or config handler 218 in FIG. 2, etc.).

While some of the forgoing examples describe accessing data (e.g., reading data) from a first memory (e.g., main system memory (e.g., memory 124 in FIG. 1)) to second memory (e.g., client memory (e.g., NPU memory 212 (e.g., cache, etc.))), the disclosure is applicable to accessing data from the second memory to the first memory.

In certain aspects, accessing (e.g., writing) data based in part on dimensional information may provide improvements to memory, such as reduced memory cleanup and longer memory life by configuring the DMA to write data to portions of the memory array (e.g., nonlinearly, etc.) so as to balance memory cell usage. In other aspects, once data is accessed by a DMA it may be addressed linearly. For example, DMA 214 in FIG. 2 may access a portion of data (e.g., in a main system memory (not shown in FIG. 2)), and write subsystem memory 224, or NPU memory 212 linearly. It will be appreciated that this may allow a processing unit of a client (e.g., a processing unit in NPU Processing units 216) to stream the accessed data linearly while DMA 214 is configured to access other data, thereby increasing efficiency and speed.

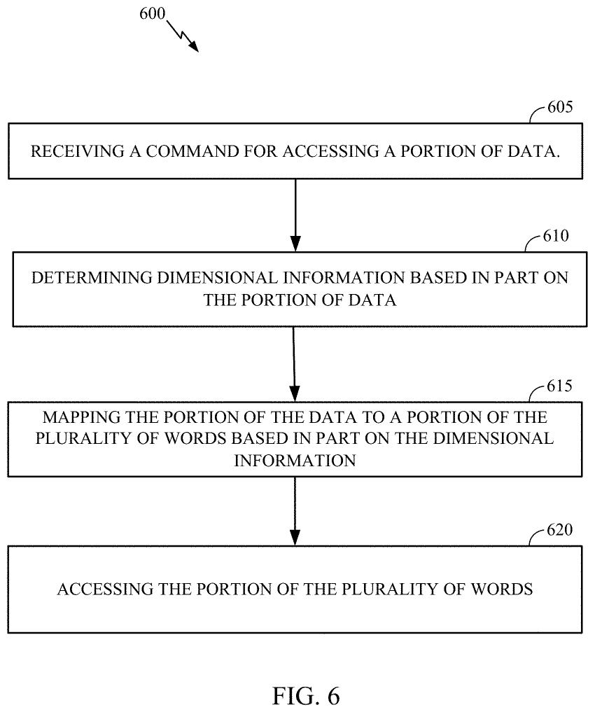

FIG. 6 is a flowchart that illustrates example operations 600 for accessing data structured as an array of words from a first memory (e.g., memory 124 in FIG. 1) with a DMA that includes hardware, software, or a combination of hardware and software (e.g., DMA 114 in FIG. 1 or DMA 214 in FIG. 2), and wherein the memory includes a plurality of words that are addressed linearly, and wherein the data (e.g., a 2D, 3D image, video, or multidimensional data) is mapped to the plurality of words.

At block 605, the DMA receives a command for accessing a portion of the data (e.g., from a client (e.g., NPU 116 in FIG. 1, NPU sub-system 200 in FIG. 2, etc.). For example, the DMA may receive a command to access data indicative of an object in a video across a number of video frames.

At block 610, the DMA determines dimensional information based in part on the portion of data associated with the command from the client. In certain aspects, the DMA can determine the location of the portion of data in the first memory based on dimensional information accessible to the DMA (e.g., information generated by the DMA (e.g., in a DMA hardware register) when the video was written to the first memory, information generated by a client, etc.)

At block 615, the DMA maps the portion of the data to a portion of the plurality of words based in part on the dimensional information. For example, the DMA can map a first word (or block) (e.g., an object in a first frame of a video mapped to a block of words) and a second word (or block) (e.g., an object in a second frame of a video mapped to a second block of words) based on the dimensional information (e.g., an offset from the first block and/or location of the second block).

At block 620, the DMA accesses the portion of the plurality of words (e.g., streaming the one or more words to one or more clients) (e.g., streaming to memory associated with the client (e.g., cache), to one or more processors of a client, etc.).

In some configurations, the term(s) ‘communicate,’ communicating,' and/or ‘communication’ may refer to ‘receive,’ receiving,“reception,' and/or other related or suitable aspects without necessarily deviating from the scope of the present disclosure. In some configurations, the term(s) ‘communicate,’ communicating,' ‘communication,’ may refer to ‘transmit,’ transmitting,”transmission,' and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

1. A method of accessing data from a first memory, the method comprising:
receiving a command for accessing a first portion of the data, wherein the data comprises a plurality of words arranged as a multi-dimensional array of words that is stored contiguously in the first memory;
mapping the first portion of the data to a first portion of the plurality of words, wherein the first portion of the plurality of words is not stored contiguously in the first memory; and
accessing the first portion of the plurality of words while refraining from accessing at least a second portion of the plurality of words that is contiguously stored between at least two words of the first portion of the plurality of words.

2. The method of claim 1, further comprising accessing dimensional information corresponding to the first portion of the data, the dimensional information indicating the first portion of the plurality of words that corresponds to the first portion of the data, wherein the mapping is performed based in part on the dimensional information.

3. The method of claim 2, wherein the dimensional information indicates a location of one or more words in the first memory associated with the first portion of the data.

4. The method of claim 3, wherein the location of the one or more words in the first memory is indicated in on one or more registers associated with the first portion of the data.

5. The method of claim 4, wherein the one or more registers are hardware registers associated with a direct memory access (DMA) controller.

6. The method of claim 2, wherein the dimensional information is programmable with a first granularity.

7. The method of claim 6, wherein the first granularity is one of a word or a block.

8. The method of claim 1, wherein the command for accessing the first portion of the data is indicative of a first word and one or more dimensions.

9. The method of claim 1, wherein accessing the first portion of the plurality of words comprises streaming the first portion of the plurality of words to a second memory.

10. The method of claim 1, wherein accessing the first portion of the plurality of words comprises streaming the first portion of the plurality of words to a processing unit.

11. The method of claim 1, wherein the command for accessing the first portion of the data is received in part from a client.

12. The method of claim 11, wherein the client comprises a neural processing unit.

13. The method of claim 1, wherein accessing the first portion of the plurality of words comprises reading the first memory.

14. The method of claim 1, wherein accessing the first portion of the plurality of words comprises writing the first memory.

15. The method of claim 14, wherein writing the first memory comprises writing dimensional information by a direct memory access (DMA) controller.

16. The method of claim 15, wherein writing dimensional information by the DMA comprises writing dimensional information to one or more registers associated with the DMA.

17. The method of claim 1, wherein the first portion of the plurality of words is not linearly stored in the first memory.

18. A system-on-chip (SoC) comprising:
a first memory storing, contiguously, data comprising a plurality of words arranged as a multi-dimensional array of words; and
a direct memory access (DMA) controller coupled to the first memory, the DMA controller being configured to:
receive a command for accessing a first portion of the data;
map the first portion of the data to a first portion of the plurality of words, wherein the first portion of the plurality of words is not stored contiguously in the first memory; and
access the first portion of the plurality of words while refraining from accessing at least a second portion of the plurality of words that is contiguously stored between at least two words of the first portion of the plurality of words.

19. The SoC of claim 18, wherein the first portion of the plurality of words is not linearly stored in the first memory.

20. The SoC of claim 18, wherein the DMA controller is further configured to access dimensional information corresponding to the first portion of the data, the dimensional information indicating the first portion of the plurality of words that corresponds to the first portion of the data, wherein the mapping is performed based in part on the dimensional information.

21. The SoC of claim 20, wherein the dimensional information indicates a location of one or more words in the first memory associated with the first portion of the data.

22. The SoC of claim 21, wherein the location of the one or more words in the first memory is indicated in on one or more registers associated with the first portion of the data.

23. The SoC of claim 18, wherein the command for accessing the first portion of the data is indicative of a first word and one or more dimensions.

24. A system-on-chip (SoC) comprising:
means for receiving a command for accessing a first portion of the data, wherein the data comprises a plurality of words arranged as a multi-dimensional array of words that is stored contiguously in the first memory;
means for mapping the first portion of the data to a first portion of the plurality of words, wherein the first portion of the plurality of words is not stored contiguously in the first memory; and
means for accessing the first portion of the plurality of words while refraining from accessing at least a second portion of the plurality of words that is contiguously stored between at least two words of the first portion of the plurality of words.

25. The SoC of claim 24, wherein the first portion of the plurality of words is not linearly stored in the first memory.

26. The SoC of claim 24, further comprising means for accessing dimensional information corresponding to the first portion of the data, the dimensional information indicating the first portion of the plurality of words that corresponds to the first portion of the data, wherein the mapping is performed based in part on the dimensional information.

27. The SoC of claim 26, wherein the dimensional information indicates a location of one or more words in the first memory associated with the first portion of the data.

28. A non-transitory computer readable medium storing instructions that when executed by a direct memory access (DMA) controller causes the DMA controller to perform a method of accessing data from a first memory, the method comprising:
receiving a command for accessing a first portion of the data, wherein the data comprises a plurality of words arranged as a multi-dimensional array of words that is stored contiguously in the first memory;
mapping the first portion of the data to a first portion of the plurality of words, wherein the first portion of the plurality of words is not stored contiguously in the first memory; and
accessing the first portion of the plurality of words while refraining from accessing at least a second portion of the plurality of words that is contiguously stored between at least two words of the first portion of the plurality of words.

29. The SoC of claim 24, wherein the first portion of the plurality of words is not linearly stored in the first memory.

30. The SoC of claim 24, wherein the method further comprises accessing dimensional information corresponding to the first portion of the data, the dimensional information indicating the first portion of the plurality of words that corresponds to the first portion of the data, wherein the mapping is performed based in part on the dimensional information.
